(19) United States
(12) Patent Application Publication
(10) Pub. No.: US 2010/0082649 A1
(43) Pub. Date: Apr. 1, 2010

(54) AUTOMATIC SEARCH SUGGESTIONS FROM SERVER-SIDE USER HISTORY

(75) Inventors: ZACHARY MARK GUTT, SEATTLE, WA (US); MICHAEL AUSTIN SCHECHTER, SAMMAMISH, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/235,413

(22) Filed: Sep. 22, 2008

(51) Int. Cl. G06F 17/30

(52) U.S. Cl. 707/758; 707/E17.014; 707/E17.032

(57) ABSTRACT

Suggested search queries are provided to a user as search assistance while a user is entering a search query but before the user submits a completed search query for a search to be performed. The suggested search queries are selected and ordered based on the user's personal search history stored server-side as well as other information available to the search engine. When a query portion is received while a user is entering a search query, previously submitted search queries are selected from the user's search history as suggested search queries. The suggested search queries are selected and/or ranked based on the user's search history and/or other information available to the search engine.

### BACKGROUND

The amount of digital information and content available on computing devices continues to grow exponentially. Given the vast amount of digital information, search engines and other search technologies have been developed to assist users in locating specific information and documents. For instance, many search engines allow users to search for documents and information available on the Internet or World Wide Web. Additionally, it is now common for individual websites and application programs to provide a search box so that users can run queries for content on that website or within that application. Similarly, desktop search techniques allow a user to search for information and documents stored on his or her computer.

Search engines typically provide an input box that allows users to enter search queries that include one or more terms that may be of interest to the users. After receiving a search query from a user, a search engine identifies documents and/or web pages that are relevant based on the terms and displays search results to the user. Because of its utility, web searching, that is, the process of finding relevant web pages and documents for user issued search queries, has arguably become the most popular service on the Internet today.

Search engine providers have developed a variety of additional features to assist users in searching. For instance, many search providers offer query suggestion functionality in which a user, having entered a particular search query, is given a set of suggested search queries related to the user's search query. The user may select one of the suggested search queries causing a search to be performed using the selected suggested search query and search results to be returned to the user. In some implementations, suggested search queries may be automatically provided as the user types in their search query but before the user initiates a search. Additionally, some implementations employ the user's own search history to suggest search queries the user has issued in the past based on what they are currently entering. These solutions, however, require users to download, install, and maintain client software to get automatic search queries suggested from their search history.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing suggested search queries based on search queries previously submitted by the user and stored in a server-side search history for the user. While the user is entering a search query but before the user submits a completed search query for a search to be performed, a search query portion is received. Using the user's personal search history in conjunction with other information available to the search engine server, suggested search queries are selected for the search query portion. The suggested search queries are provided to the user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed to identify suggested search queries based on user search history stored server-side;

FIG. 3 is a flow diagram showing a method for selecting and ordering suggested search queries based on a user's search history stored server-side in accordance with an embodiment of the present invention;

FIG. 4 is a flow diagram showing a method for selecting and ordering suggested search queries based on a user's search history stored server-side in accordance with another embodiment of the present invention; and

FIG. 5 is an illustrative screen display showing suggested search queries that are presented as a user is entering a search query in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to providing suggested search queries to a user by employing the user's search history stored server-side. The suggested search queries are provided to the user while the user is entering a search query but before the search query is completed and submitted by the user for a search to be performed. As a user incrementally enters each character of a search query, a portion of the search query is received. For instance, if the user intends to enter the search query “computer,” the query portions received as the user types would include “c,” “co,” “com,” “comp,” “compu,” “comput,” “compute”, and “computer.” As each query portion is received, suggested search queries are determined for the query portion. As used herein, the term “suggested search query” refers to a search query that is selected based on a received query portion and provided to the user as a suggestion for performing a search. By way of example, if the user has typed “co,” the suggested search queries may include, for instance, “coffee, “computer,” “condo,” “fair trade coffee, “incorporated,” and “tea.” In some instances, the suggested search queries include the string from the query portion (i.e., “co”) at the beginning or middle of a term; while in other instances, the suggested search queries may be related concepts and terms that don't include the string (e.g., tea is related to coffee). By presenting suggested search queries as the user is entering the search query, the user does not need to complete entering the entire search query or the user may be presented with a search query the user prefers over what the user originally intended to enter. The user may select a suggested search query and cause a search to be performed using the selected search query.

In accordance with embodiments of the present invention, suggested search queries are selected from the user's search history, which is stored server-side such that it is accessible by a search engine server. Among possible other information, the user's search history includes search queries the user has submitted in the past. When the user is entering a search query, a query portion is received and previously submitted search queries are identified from the user's search history based on the query portion and returned to the user as suggested search queries. The suggested search queries are selected from the user's search history and ordered using other information available to the search engine beyond just the user's search history. By way of example only and not limitation, the other information that is available to the search engine that may be used to select and order suggested search queries includes: the search engine index (which stores information regarding web pages and documents crawled by the search engine), query logs (which store information regarding search queries submitted to the search engine and search results), and user search history information for users other than the user entering the current search query.

In further embodiments of the present invention, user search history stored server-side may be employed to select and rank suggested search queries that are identified from sources available to the search engine other than the user's search history. In particular, when a query portion is received, suggested search queries may be identified from the other sources as being relevant to the query portion. Those suggested search queries are ranked based at least in part on the user's search history to aid in selecting and/or ordering the suggested search queries to return to the user.

According, in one aspect, an embodiment of the present invention is directed to a computer-implemented method for a server-side search engine to provide suggested search queries from a server-side user search history for a user. The method includes receiving user input representing a portion of a search query. The user input is received prior to receiving a user command to perform a search using a completed search query. The method also includes selecting and ordering, from the server-side user search history, search queries previously submitted to the search engine by the user, wherein the search queries are selected and ordered as suggested search queries based at least in part on relevance of the search queries to the portion of the search query and based at least in part on other information available to the search engine. The method further includes communicating the suggested search queries for presentation to the user.

In another embodiment, an aspect of the invention is directed to one or more computer-storage media storing computer-useable instructions for causing a server-side search engine to perform a method for providing suggested search queries based on server-side user search history information. The method steps are performed incrementally as a user incrementally enters characters to form a portion of a search query. The method includes receiving the portion of the search query. The method also includes accessing the server-side user search history information for the user, wherein the server-side user search history information includes previous search queries submitted by the user to the server-side search engine. The method further includes accessing other information available to the server-side search engine from at least one of: (1) a search engine index containing information obtained by crawling documents to be searched using the server-side search engine, and (2) query logs maintained by the server-side search engine. The method also includes selecting and ordering, from the server-side user search history information, previous search queries as suggested search queries based at least in part on a relevance of the search queries to the portion of the search query and based at least in part on at least a portion of the other information available to the server-side search engine. The method still further includes communicating the suggested search queries for presentation to the user.

A further aspect of the invention is directed to one or more computer-storage media storing computer-useable instructions for causing a server-side search engine to perform a method for providing suggested search queries based on server-side user search history information for a user. The method includes receiving user input representing a search query portion, the user input being received prior to receiving a user command to perform a search using a completed search query. The method also includes accessing the server-side search history information for the user, the server-side search history information including previously submitted search queries from the user. The method further includes identifying previously submitted search queries from the server-side search history information as suggested search queries based on the search query portion. The method also includes accessing other information available to the server-side search engine. The method further includes ranking the suggested search queries based at least in part on the other information available to the server-side search engine. The method still further includes communicating at least a portion of the suggested search queries for presentation to the user.

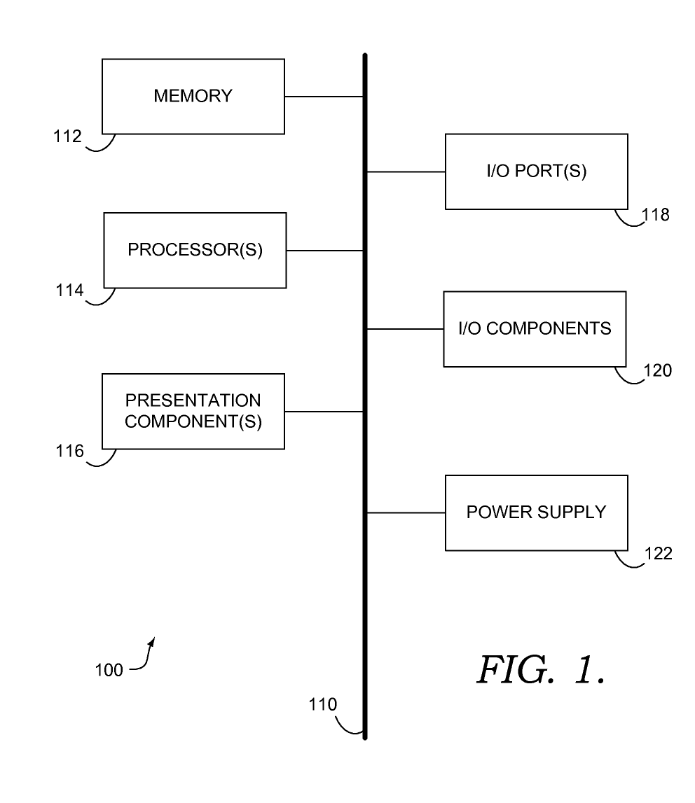

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

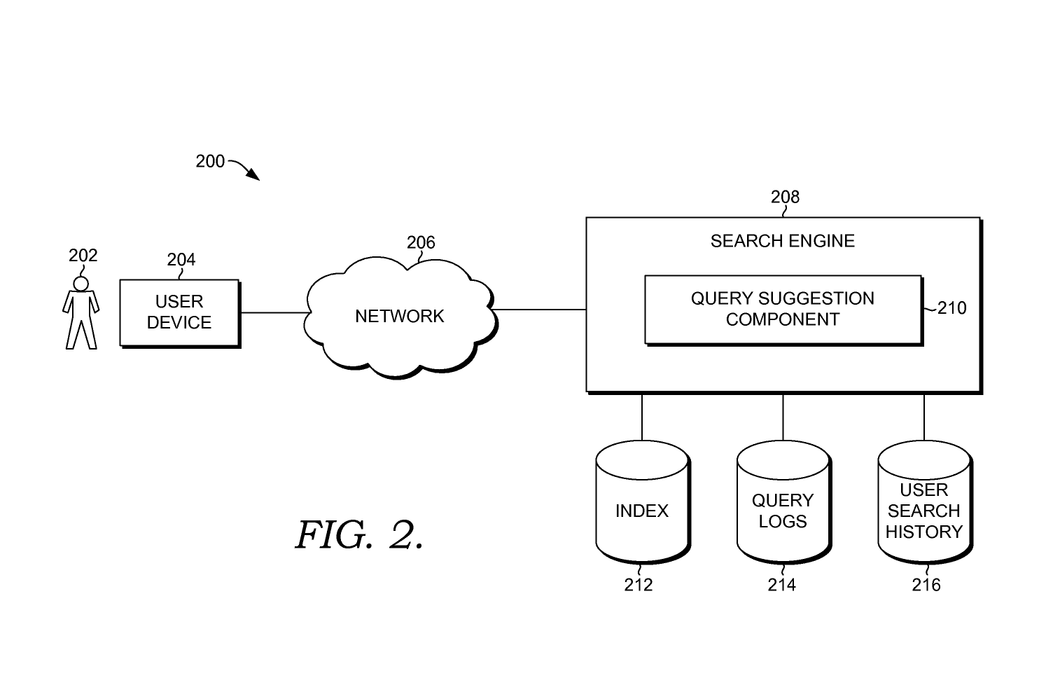

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 generally includes a user device 204 and a search engine 208. The user device 204 and search engine 208 may each include any type of computing device, such as computing device 100 described with reference to FIG. 1, for example. The components of the system 200 may communicate with each other via a network 206, which may include, without limitation, one or more local area networks (LANs) and/or wide area networks (WANs). Such networking environments are commonplace in offices, enterprise-wide computer networks, intranets, and the Internet. It should be understood that any number of user devices, search engines, and networks may be employed within the system 200 within the scope of the present invention. Each may comprise a single device or multiple devices cooperating in a distributed environment. For instance, the search engine 208 may comprise multiple devices arranged in a distributed environment that collectively provide the functionality of the search engine 208 described herein. Additionally, other components not shown may also be included within the system 200.

Generally, the system 200 illustrates an environment in which a user 202 may employ a user device 204 to issue search queries via the network 206 to the search engine 208, which returns search results based on the user's search query. As known in the art, the search engine 208 may generally include a crawler (not shown) for crawling web pages and other documents and indexing information in an index 214. By indexing information from web pages and other documents, the search engine 208 may provide search capabilities to users, such as the user 202. In particular, the user 202 may employ a web browser or other mechanism on the user device 204 to communicate with the search engine 208. For instance, the user 202 may issue a search query to the search engine 208. In response, the search engine 208 may generate a set of search results for the search query using information in the index 212. The search results correspond with web pages and other documents crawled by the search engine 208. The search results are returned by the search engine 208 to the user device 204 for presentation to the user.

In addition to the index 212 that stores information regarding web pages and other documents, the search engine 208 also has access to a variety of other information. For instance, the search engine 208 maintains query logs 214. At a minimum, the query logs 214 contain information regarding search queries previously submitted by users to the search engine 208. The query logs 214 may include additional information, such as search results selected by users in response to the various search queries.

The search engine 208 also maintains a user search history data store 216. In embodiments, the user search history data store 216 stores search history information for a number of users and may identify each user and each user's search history using some unique identifier. As such, each user's search history may be identified when the user interacts with the search engine 208. It should be noted that data stored in the user search history data store 216 may be used anonymously by the system.

Among other information, a user's search history may include search queries previously submitted by each particular user to the search engine 208. A user's search history may also include other information, such as search results that user has selected for each search query. In some embodiments, the search engine 208 may provide browsing features that allow users to employ “clicks” to navigate through results and information that is held by the search engine (as opposed to just employing user-entered search queries). In such embodiments, the user's search history may include information such as user clicks on browse-focused pages.

In some embodiments, information in the user search history data store 216 may be derived from information in the query logs 214. In other embodiments, user search history information may be tracked by the search engine 208 independently of the query logs during user search sessions and stored in the user search history data store 216. In further embodiments, user search history information may be tracked and stored client-side on user devices (e.g., on the user device 204) and periodically communicated from the user devices to the search engine 208, which stores the information in the user search history data store 216. In still further embodiments, the search engine 208 does not include a separate user search history data store 216 but, instead, indicates user identification information with entries in the query logs 214 to identify users with search information included in the query logs 214. Any and all such variations are contemplated to be within the scope of embodiments of the present invention.

In addition to the information available in the index 212, query logs 214, and user search history data store 216, those skilled in the art will recognize that the search engine 208 may have access to a variety of additional information.

In the embodiment illustrated in FIG. 2, the search engine 208 includes a query suggestion component 210 that is configured to provide search suggestions to the user 202 as the user 202 incrementally enters a search query employing the user device 204. In some embodiments, the search engine 208 incrementally receives portions of a search query as a user 202 enters each character. A new search query portion may be received after each keystroke or other input by the user. For instance, suppose the user 202 wishes to enter the search query “coffee.” The portions received by the search engine 208 as the user 202 types each character would include “c,” “co,” “cof,” “coff,” “coffe,” and “coffee.” As such, the term “portion” is used herein to include a 100 percent, completed search query, as well as any percentage of a completed search query under 100 percent (i.e., an incomplete search query). In some embodiments, time-based approaches may be employed to provide query portions to the search engine 208. For instance, the search engine 208 may continuously receive a query portion each time a predetermined period of time lapses, whether or not the query portion has changed during that time period. In other embodiments, the query portion may be analyzed at predetermined time intervals for changes and each time a change is identified, the search engine 208 receives the new query portion. Any and all such variations are contemplated to be within the scope of embodiments of the present invention.

As each portion of the search query is incrementally received while the user 202 is entering the search query, the query suggestion component 210 identifies suggested search queries that may be provided to the user 202. Generally, the query suggestion component 210 may attempt to determine what search query the user 202 intends to submit before the user 202 actually completes entering the search query and submits the completed search query. Additionally, the query suggestion component 210 may attempt to suggest search queries related to what the user is entering as the user may prefer to user a different search query over what the user originally intended to enter.

In embodiments, the query suggestion component 210 identifies suggested search queries based on search queries that the user 202 previously submitted to the search engine 208 that have been stored in the user search history data store 216. When the user 202 interacts with the search engine 208, the user 202 is identified, for instance by requiring the user to log in or provide some identifying information, using cookies, or by some other mechanism. Identifying the user may or may not require the user to explicitly authenticate himself/herself to the system. By identifying the user 202, the search engine 208 may identify the user's personal search history within the user search history data store 216. As such, when the search engine 208 receives a query portion from the user 202, the query suggestion component 210 accesses that user's personal search history to identify previously submitted search queries that may be provided to the user as suggested search queries based on the query portion. For instance, if the user 202 has entered “co,” the query suggestion component 210 accesses the user's search history and recognizes that the user 202 has previously submitted the search queries, “computer,” “coffee,” and “condo” that are relevant to the query portion. As such, the user 202 may be provided with those terms as suggested search queries based on the query portion entered by the user.

The previously submitted search queries that are identified by the query suggestion component 210 are selected and ordered based at least in part on a textual-based relevance of the previously submitted search queries to the received query portion. In particular, the query portion comprises a string of text. The query suggestion component 210 identifies previously submitted search queries in the user's personal search history that match that string of text. For instance, in the example above in which the user has enter the query portion “co,” the previously submitted search queries, “computer,” “coffee,” and “condo” are identified since they include the string “co.”

The query suggestion component 210 may also use other information available to the search engine 208 to select and order previously submitted search queries as suggested search queries. Other information available to the search engine 208 that may be used by the query suggestion component 210 includes information collected from web pages and other documents and stored in the index 212, as well as information, such as search queries and selected search results, in the query logs 214. The query suggestion component 210 may also employ search history information from users other than the user 202 who entered the query portion. For instance, suppose that the user entering the current search query “co,” has previously submitted the search queries “condo” and “coffee” the same amount of times. Search history information for other users from the query logs 214 or other sources may be used to determine which term is more popular and rank that one higher. Those skilled in the art will recognize that the search engine 208 may have access to a variety of additional information that may be used to select and order search queries previously submitted by the user 202 as suggested search queries for a given query portion.

The query suggestion component 210 may employ algorithms that concurrently use both the user's personal search history and other information available to the search engine to select and rank suggested search queries in some embodiments. In other embodiments, the query suggestion component 210 may first identify previously submitted search queries from the user's search history that have a text-based relevance to the query portion and subsequently employ other information available to the search engine to rank the previously submitted search queries as suggested search queries.

In some embodiments, information available to the search engine 208 other than the user's own personal search history may be used in ranking and ordering suggested search queries identified from the user's past search queries. For instance, the other information may be used to rank some suggested search queries higher while causing other suggested search queries to be ranked lower.

By way of example, other information available to the search engine may be used to identify currently popular topics, which may in turn be used to rank and order the suggested search queries. For instance, search queries submitted by users and stored in the query logs 214 may be analyzed to determine currently popular topics. In particular, if a large number of search queries related to a given topic are submitted by users over a given time period, that topic can be considered to be popular at that time. In other words, query frequency may be used to identify popular search queries and terms. Indexed information from web pages and documents in the index 212 could also be analyzed to identify currently popular topics. For instance, information from news-related documents could be analyzed to determine current events. In some cases, the index 212 includes statistical information, which can be analyzed to identify currently popular topics. In some embodiments, the user 202 may be identified as belonging to a particular social network. In particular, the user 202 is identified as being associated with a particular group of users. As such, search history information for the users within that social network may be identified from the user search history data store 216 and topics popular to the users in the social network may be identified.

By identifying currently popular topics from query logs 214, the index 212, or another source, the information may be used to rank and order suggested search queries for the user 202. In particular, if a suggested search query identified from a search query previously submitted by the user 202 is determined to have relevance to a currently popular topic, the suggested search query may be ranked higher and placed higher in a list of suggested search queries provided to the user 202. For instance, suppose that the user 202 has entered the query portion “bar” and the following previously submitted search queries are identified from the user's search history: “barbie,” “barack obama,” and “barnes and noble.” Based on other information available to the search engine 208, it is also determined that “barack obama” is a currently popular topic due to the current United States Presidential elections. As such, the “barack obama” suggested search query would be ranked higher than the other suggested search queries identified from the user's search history.

In further embodiments, information available to the search engine 208 other than the user's own personal search history may be used to identify search queries previously submitted by the user as suggested search queries that would not have been identified using just a text-based relevancy approach and the user's search history alone. For instance, suppose that the user 202 previously submitted the search queries, “lottery” and “powerball,” which are stored in the user's personal search history. If the user 202 enters the query portion “lot,” using just a text-based relevancy approach and the user's search history alone, only the “lottery” search query would be identified since “powerball” does not include the string “lot” (or even a close match of that string). However, analyzing other information available to the search engine, such as information in the index 212 and query logs 214, may help to identify “lottery” and “powerball” as related terms. As such, by using this other information in addition to the user's search history, both “lottery” and “powerball” may be identified from the user's search history as suggested search queries for the query portion “lot.” As a further example, suppose that the user 202 had previously submitted only the search query “powerball” and had not previously submitted the search query “lottery.” By employing other information available to the search engine 208, embodiments of the present invention may still be able to identify “powerball” from the user's search history as a suggested search query when the user has entered the query portion “lot.” In particular, when the user enters the query portion “lot,” the search engine 208 identifies “lottery” as a suggested search query from other sources and recognizes that “powerball” from the user's search history is a related term based on information available to the search engine 208.

In addition to identifying suggested search queries for a query portion based on the user's search history, the query suggestion component 210 may also identify other suggested search queries independently of the user's personal search history. For instance, the query suggestion component 210 may identify suggested search queries for a query portion by comparing the query portion to information in the index 212 and/or query logs 214 to identify additional suggested search queries. The suggested search queries identified from the user's personal search history and the additional suggested search queries identified independent of the user's personal search history could be combined and provided to the user in a combined suggested search query list as the user enters the search query. In some embodiments, the two types of suggested search queries may be comingled and ranked together in a single listing, while in other embodiments, the two types of suggested search queries may be provided in separate lists.

In some embodiments, suggested search queries identified from sources other than the user's personal search history may be ranked based at least in part on information from the user's personal search history. In particular, upon identifying a suggested search query from a source other than the user's personal search history, the ranking of the suggested search query may be affected by information in the user's personal history, such as causing a higher or lower ranking. For instance, suppose that the user 202 has typed “foo” in the search box, and the search engine 208 suggests “food,” “food network,” “food tv,” “food pyramid,” “foot locker,” and “football” as suggested search queries based on other information available to the search engine 208. If there are a lot of sports searches in the user's search history, the search engine 208 may decide to adjust the ranking to reflect this. For example, “football” could be ranked higher based on the user's search history such that it is located at the top of the list. In this scenario, none of the suggested search queries would need to be in the user's search history.

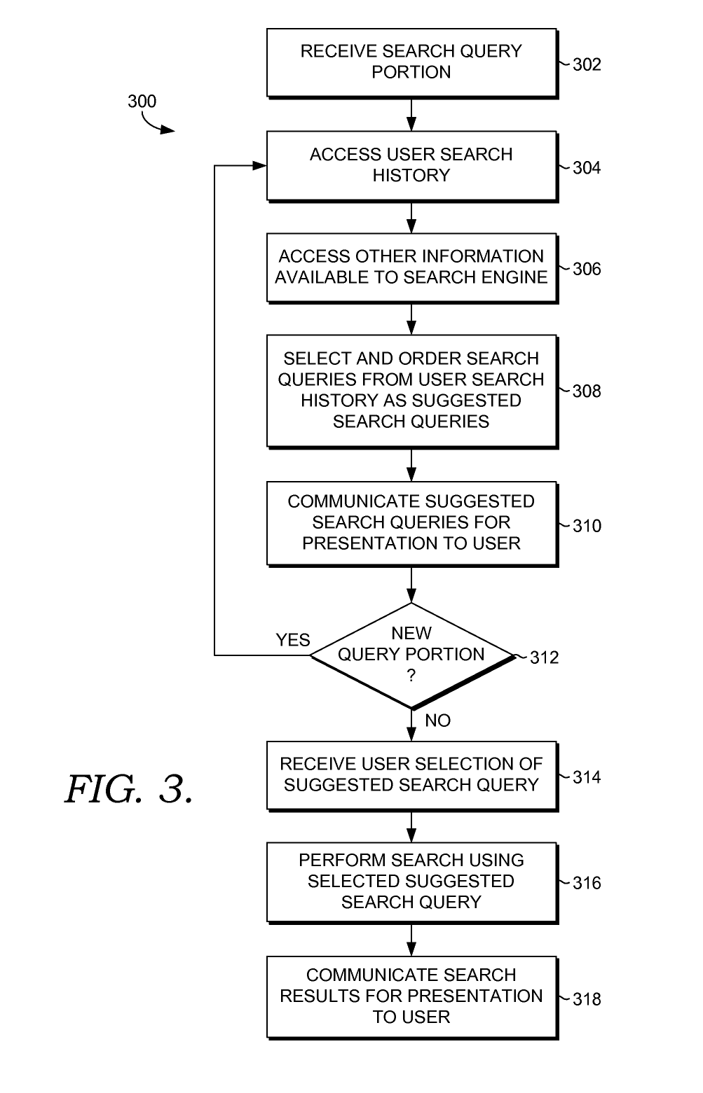

Turning now to FIG. 3, a flow diagram is provided illustrating a method 300 for providing suggested search queries based on server-side user search history in accordance with an embodiment of the present invention. As shown at block 302, a portion of a search query is initially received. For instance, if the user intended to enter the search query “computer,” the initial query portion received would be “c.”

As shown at block 304, search history information for the user who entered the search query portion is accessed. The user's search history contains information including past search queries submitted by the user and may include additional information, such as search results that the user has selected for each search query. In some embodiments, to access the user's search history, the user is first identified, for instance, by requiring the user to log in, employing a cookie, or using some other mechanism for identifying the user. After identifying the user, search history information corresponding with that user may be accessed.

Other information available to the search engine is also accessed, as shown at block 306. The other information may be from a variety of sources, including, for instance, the search engine index, query logs, and user search histories (for users other than the user entering the search query portion). It should be understood that other information may be available to the search engine and accessed.

Search queries previously submitted by the user who entered the query portion are identified from the user's personal search history and ranked as suggested search queries, as shown at block 308. The previously submitted search queries are selected and ranked based at least in part on a textual-matching of the query portion string to the previously submitted search queries. The previously submitted search queries are also selected and ranked as suggested search queries based at least in part on the other information available to the search engine and accessed at block 306. As such, suggested search queries are selected and ranked by employing both the user's search history and other information available to the search engine.

As shown at block 310, the identified suggested search queries are communicated for presentation to the user. For instance, the suggested search queries are communicated from a search engine server to the user's computer for presentation (e.g., on a display device). In some embodiments, only the suggested search queries from the user's personal search history are communicated for presentation to the user. In other embodiments, additional suggested search queries may be identified independent of the user's previously submitted search queries. For instance, additional suggested search queries may be identified by comparing the search query portion to search queries in query logs or information contained in a search engine's index. In such embodiments, both types of suggested search results are communicated to the user for presentation either in separate lists or comingled and ranked against each other in a common list. In some embodiments, only the highest ranked suggested search queries are returned to the user. For instance, only the top five suggested search queries may be returned. In other embodiments, all identified suggested search queries are provided to the user.

As discussed previously, embodiments of the present invention operate to provide suggested search queries while the user is entering a search query but before the user actually submits a completed search query. For instance, each time a user edits the query portion, suggested search queries may be provided. Accordingly, a determination is made at block 312 as to whether the portion of the search query has changed. It should be noted that receiving a new query portion includes a user adding or deleting a character from the previous query portion. For instance, continuing the example in which the user intends to enter “computer” and has initially entered “c,” a new query portion is received when the user adds an “o” to create the query portion “co.” The user may then decide to delete the “o,” causing a new query portion to be received as a result of the deletion. As noted above, the system may employ a number of approaches for monitoring changes to the query portion beyond explicit keystrokes, such as time-based approaches.

If a new query portion is received at block 312, the process of identifying suggested search queries from block 304 through block 310 is repeated. Additionally, this method of refreshing the suggested search queries may continue until the user has completed inputting his/her search query.

At some point while the user is inputting the search query but before the user finishes, the user may identify a suggested search query the user would like to use to have a search performed. In some embodiments, the suggested search queries may be user-selectable. For instance, by selecting a suggested search query, the selected search query is indicated in the input box and the user may select a “search” button to cause a search to be performed using the selected suggested search query. In other instances, selecting a suggested search query may automatically cause a search to be performed using the selected suggested search query. Accordingly, the user may choose to select a particular suggested search query, and the selection of the suggested search query is received, as shown at block 314. The user may use, for example, a mouse, keyboard, touchscreen, joystick, or any other input device to select the search result. Based on the user selection, a search is performed using the selected suggested search query as the search query, as shown at block 316. Search results from the search are communicated for presentation to the user at block 318. For instance, a search results user interface may be communicated from a search engine server to a user device for presentation (e.g., on a display device).

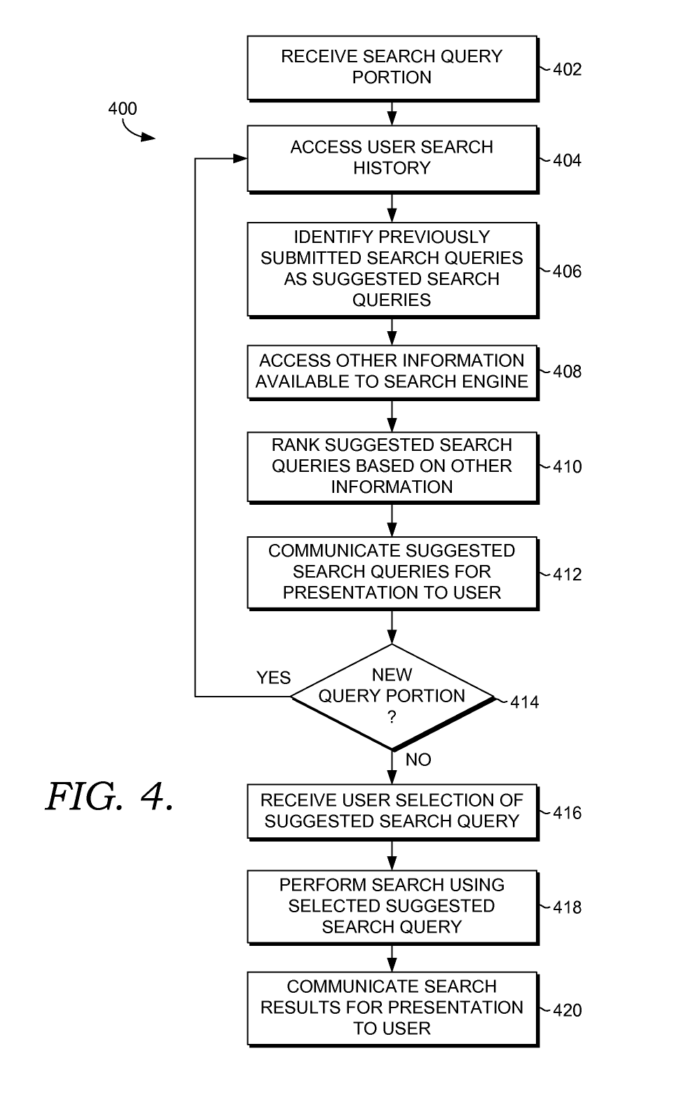

With reference now to FIG. 4, a flow diagram is provided illustrating another method 400 for providing suggested search queries based on server-side user search history in accordance with an embodiment of the present invention. As shown at block 402, a portion of a search query is initially received. For instance, if the user intended to enter the search query “computer,” the initial query portion received would be “c.”

As shown at block 404, search history information for the user who entered the search query portion is accessed. The user's search history contains information including past search queries submitted by the user and may include additional information, such as search results that the user has selected for each search query. In some embodiments, to access the user's search history, the user is first identified, for instance, by requiring the user to log in, employing a cookie, or using some other mechanism for identifying the user. After identifying the user, search history information corresponding with that user may be identified.

Using the search query portion and the user's personal search history, search queries previously submitted by the user who entered the query portion are identified from the user's personal search history as suggested search queries, as shown at block 406. In particular, text-based relevance to the query portion may be determined for previously submitted search queries. Previously submitted search queries that include portions that match or nearly match the query portion string are identified as suggested search queries.

Other information available to the search engine beyond the user's personal search history is also accessed, as shown at block 408. The other information may be from a variety of sources, including, for instance the search engine index, query logs, and user search histories (for users other than the user entering the search query portion). It should be understood that other information may be available to the search engine and accessed.

As shown at block 410, the suggested search queries that were identified at block 406 are ranked based at least in part on the other information accessed at block 408. In some embodiments, the suggested search queries are initially ranked based on text-based relevance to the query portion string and then re-ranked based on the other information available to the search engine. In other embodiments, the suggested search queries are ranked based on a combination of text-based relevance and using other information available to the search engine. In further embodiments, the suggested search queries are ranked solely on the other information available to the search engine. Any and all such variations are contemplated to be within the scope of embodiments of the present invention. Ranking the suggested search queries allows for the determination of an order to list the suggested search queries and/or allows a determination of which suggested search queries to provide to the user (e.g., only the top N ranked suggested search queries are provided).

The suggested search queries are communicated for presentation to the user at block 412. For instance, the suggested search queries are communicated from a search engine server to the user's computer for presentation (e.g., on a display device). In some embodiments, only the suggested search queries from the user's personal search history are communicated for presentation to the user. In other embodiments, additional suggested search queries may be identified independent of the user's previously submitted search queries. For instance, additional suggested search queries may be identified by comparing the search query portion to search queries in query logs or information contained in a search engine's index. In such embodiments, both types of suggested search results are communicated to the user for presentation either in separate lists or comingled and ranked against each other in a common list. In some embodiments, only the highest ranked suggested search queries are returned to the user. For instance, only the top five suggested search queries may be returned. In other embodiments, all identified suggested search queries are provided to the user.

As discussed previously, embodiments of the present invention operate to provide suggested search queries while the user is entering a search query but before the user actually submits a completed search query. For instance, each time a user edits the query portion, suggested search queries may be provided. Accordingly, a determination is made at block 414 as to whether the portion of the search query has changed. It should be noted that receiving a new query portion includes a user adding or deleting a character from the previous query portion. For instance, continuing the example in which the user intends to enter “computer” and has initially entered “c,” a new query portion is received when the user adds an “o” to create the query portion “co.” The user may then decide to delete the “o,” causing a new query portion to be received as a result of the deletion.

If a new query portion is received at block 414, the process of identifying suggested search queries from block 404 through block 412 is repeated. Additionally, this method of refreshing the suggested search queries may continue until the user has completed inputting his/her search query.

At some point while the user is inputting the search query but before the user finishes, the user may identify a suggested search query the user would like to use to have a search performed. In some embodiments, the suggested search queries may be user-selectable. For instance, by selecting a suggested search query, the selected search query is indicated in the input box and the user may select a “search” button to cause a search to be performed using the selected suggested search query. In other instances, selecting a suggested search query may automatically cause a search to be performed using the selected suggested search query. Accordingly, the user may chose to select a particular suggested search query, and the selection of the suggested search query is received, as shown at block 416. The user may use, for example, a mouse, keyboard, touchscreen, joystick, or any other input device to select the search result. Based on the user selection, a search is performed using the selected suggested search query as the search query for the search, as shown at block 418. Search results from the search are communicated for presentation to the user at block 420. For instance, a search results user interface may be communicated from a search engine server to a user device for presentation (e.g., on a display device).

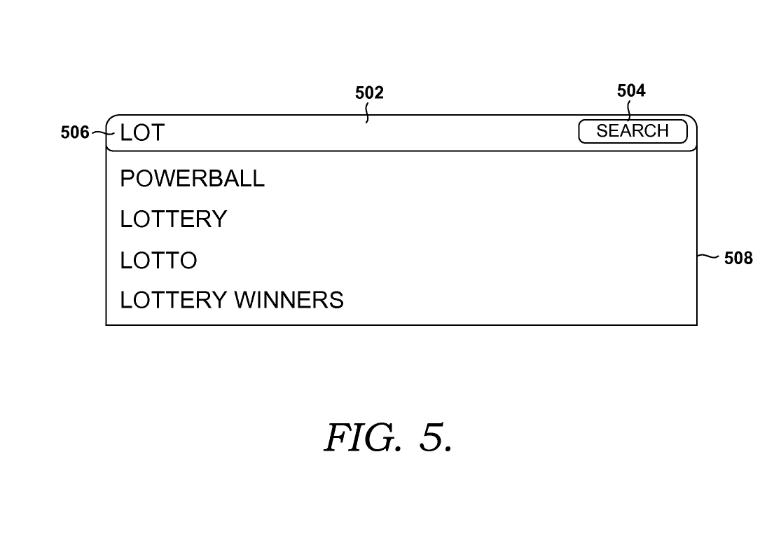

Turning now to FIG. 5, an exemplary screen display portion is provided illustrating suggested search queries being provided while a user is entering a search query portion in accordance with an embodiment of the present invention. It will be understood and appreciated by those of ordinary skill in the art that the screen display of FIG. 5 is provided by way of example only and is not intended to limit the scope of the present invention in any way.

As shown in FIG. 5, a search input box 502 is provided that allows a user to enter a search query. Additionally, a search button 504 is provided that allows the user to submit the search query to a search engine such that search results are returned in response to the search query. In the present example, the user has started typing a search query and has entered the query portion 506 “lot.” Based on the query portion 506, a number of suggested search queries are provided in a dropdown box 508. It should be noted that the suggested search queries are automatically provided as the user is entering text in the search input box 502 without requiring the user to select the search button 504. The suggested search queries include “powerball,” “lottery,” “lotto,” and “lottery winners.” Each of the suggested search queries may be user selectable to cause a search to be performed using a selected suggested search query.

FIG. 5 illustrates the example discussed above in which the user has previously submitted the search query “powerball.” Suppose, for instance, that the user wishes to get back to the search results the user had previously accessed when using the search query “powerball,” but the user doesn't recall the exact search query previously used. As such, the user begins to type “lottery” and, in the present example, has entered the query portion 506 “lot.”

As noted above, based on the query portion 506 “lot,” analyzing the user's personal search history using text-based relevancy alone would only be able to identify past search queries from the user's search history that include portions that match or closely match the string “lot” if any such past search queries exist. However, such an approach would not be able to identify “powerball” since it does not match the string “lot.”

In the present example, the search engine identifies a number of suggested search queries, including “lottery,” “lotto,” and “lottery winners,” from sources available to the search engine other than the user's personal search history (e.g., a search engine index or query logs). These suggested search queries would be considered “popular search queries” since they are search queries popular to the search engine users generally. Additionally, by employing information available to the search engine (e.g., search engine index, query logs, etc.) beyond the user's personal search history, “powerball” is identified as corresponding with terms such as “lottery” and “lotto.” As such, since the user previously submitted the search query “powerball,” that previously submitted search query may be identified from the user's personal search history as a suggested search query based on the search query portion 506 “lot.”

As can be understood, embodiments of the present invention provide suggested search queries while a user enters a search query. The suggested search queries are selected and ordered based on the user's search history in conjunction with other information available to the search engine. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method for a server-side search engine to provide suggested search queries from a server-side user search history for a user, the method comprising:
receiving user input representing a portion of a search query, the user input being received prior to receiving a user command to perform a search using a completed search query;
selecting and ordering, from the server-side user search history, one or more search queries previously submitted to the search engine by the user, wherein the one or more search queries are selected and ordered as one or more suggested search queries based at least in part on relevance of the one or more search queries to the portion of the search query and based at least in part on other information available to the search engine; and
communicating the one or more suggested search queries for presentation to the user.

2. The computer-implemented method of claim 1, wherein the other information available to the server-side search engine comprises information collected from web pages and other documents and stored in a search engine index used for providing search results in response to search queries.

3. The computer-implemented method of claim 1, wherein the other information available to the server-side search engine comprises information in query logs.

4. The computer-implemented method of claim 1, wherein the other information available to the server-side search engine comprises user search history for other users.

5. The computer-implemented method of claim 4, wherein the other users include users identified as being within a social network with the user.

6. The computer-implemented method of claim 1, wherein the method further comprises:
identifying one or more additional suggested search queries independent of the server-side user search history for the user; and
communicating the one or more additional suggested search queries for presentation to the user.

7. The computer-implemented method of claim 6, wherein the one or more additional suggested search queries are identified based at least in part on a comparison of the query portion to at least one of: a search engine index, and query logs.

8. The computer-implemented method of claim 6, wherein the one or more suggested search queries and the one or more additional suggested search queries are provided in separate lists.

9. The computer-implemented method of claim 6, wherein the one or more suggested search queries and the one or more additional suggested search queries are ranked against each other and comingled together in a common list provided to the user.

10. The computer-implemented method of claim 1, wherein the one or more suggested search queries each include an embedded link, allowing for user selection of the one or more suggested search queries.

11. The computer-implemented method of claim 1, wherein the method further comprises:
receiving input indicative of a user selection of a suggested search query from the one or more suggested search queries;
performing a search using the selected suggested search query to generate search results; and
communicating the search results for presentation to the user.

12. One or more computer-storage media storing computer-useable instructions for causing a server-side search engine to perform a method for providing suggested search queries based on server-side user search history information, the method comprising:
as a user incrementally enters characters to form a portion of a search query, upon each increment:
receiving the portion of the search query;
accessing the server-side user search history information for the user, the server-side user search history information including previous search queries submitted by the user to the server-side search engine;
accessing other information available to the server-side search engine from at least one of: (1) a search engine index containing information obtained by crawling a plurality of documents to be searched using the server-side search engine, and (2) query logs maintained by the server-side search engine;
selecting and ordering, from the server-side user search history information, a plurality of previous search queries as a plurality of suggested search queries based at least in part on a relevance of the plurality of search queries to the portion of the search query and based at least in part on at least a portion of the other information available to the server-side search engine; and
communicating the plurality of suggested search queries for presentation to the user.

13. The one or more computer-storage media of claim 12, wherein the method further comprises:
identifying a plurality of additional suggested search queries independent of the server-side user search history for the user; and
communicating the plurality of additional suggested search queries for presentation to the user.

14. The one or more computer-storage media of claim 13, wherein the plurality of suggested search queries and the plurality of additional suggested search queries are provided in separate lists.

15. The one or more computer-storage media of claim 13, wherein the plurality of suggested search queries and the plurality of additional suggested search queries are ranked against each other and comingled together in a common list provided to the user.

16. The one or more computer-storage media of claim 12, wherein the method further comprises:
receiving input indicative of a user selection of a suggested search query from the plurality of suggested search queries;
performing a search using the selected suggested search query to generate search results; and
communicating the search results for presentation to the user.

17. One or more computer-storage media storing computer-useable instructions for causing a server-side search engine to perform a method for providing suggested search queries based on server-side user search history information for a user, the method comprising:
receiving user input representing a search query portion, the user input being received prior to receiving a user command to perform a search using a completed search query;
accessing the server-side search history information for the user, the server-side search history information including a plurality of previously submitted search queries from the user;
identifying one or more previously submitted search queries from the server-side search history information as one or more suggested search queries based on the search query portion;
accessing other information available to the server-side search engine;
ranking the one or more suggested search queries based at least in part on the other information available to the server-side search engine; and
communicating at least a portion of the one or more suggested search queries for presentation to the user.

18. The one or more computer-storage media of claim 17, wherein the other information available to the server-side search engine comprises one or more of the following:
information collected from web pages and other documents and stored in a search engine index used for providing search results in response to search queries;
information in query logs; and
user search history for other users.

19. The one or more computer-storage media of claim 17, wherein the at least a portion of the one or more suggested search queries are selected for communication to the user based on rankings associated with each of the one or more suggested search queries.

20. The one or more computer-storage media of claim 17, wherein the at least a portion of the one or more suggested search queries are ordered based on rankings associated with each of the one or more suggested search queries.
